(19) United States
(12) Patent Application Publication
(10) Pub. No.: US 2009/0058662 A1
(43) Pub. Date: Mar. 5, 2009

(54) Safe dining implement structure with temperature measuring and warning function

(76) Inventor: Alan Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,990

(22) Filed: Aug. 29, 2007

(51) Int. Cl. G08B 17/00

(52) U.S. Cl. 340/584

(57) ABSTRACT

A dining implement includes a dining implement body, and a warning device fitted to the dining implement body; the warning device includes a power source, a temperature measuring device to measure temperature of foods, a vibrator, a sound giving-off device, and several power sources, which include blue, yellow, and red ones; the vibrator will start vibrating, the sound giving-off device will give off warning sound, and the light sources will emit warning light accordingly if the temperature of the foods is higher than a predetermined value; thus, even if the user is a person with disabilities, he can be aware of the high temperature of the foods, thus preventing himself from getting hurt.

### BACKGROUND OF THE INVENTION

1. Field of the Invention

The present invention relates to a dining implement, more particularly one, which is equipped with a warning device including a temperature measuring device, a vibrator, a sound giving-off device, and several light sources to prevent the user from getting hurt by very hot foods; thus, little children, elderly persons, and persons with disabilities can be aware of high temperature of the foods.

2. Brief Description of the Prior Art

Little children, the elderly, and persons with disabilities usually can't dine by themselves therefore they need to be fed by other people. The diners/feeders usually measure the temperature of the foods in order to make sure that the foods are neither too hot nor too cool before they eat/feed the foods to little children, the elderly, and persons with disabilities. Various dining implements are used in dining, e.g. thermos bottles, chopsticks, forks, spoons, bowls, and dishes. The above method is found to have the following drawbacks:

1. Common dining implements aren't equipped with a temperature device. Therefore, the diners/feeders have to use a thermometer to measure the temperature of foods before they eat/feed the foods to little children, the elderly, and persons with disabilities.

2. Other people have to make sure in advance that the temperature of foods is moderate for the little children/the elderly/people with visual disabilities if the little children/the elderly/people with visual disabilities intend to dine with conventional dining implements by themselves. Therefore, it is inconvenient.

### SUMMARY OF THE INVENTION

It is a main object of the present invention to provide an improvement on a dining implement to overcome the above problems.

A dining implement according to an embodiment of the present invention includes a dining implement body, and a warning device. The warning device includes a power source, a temperature measuring device to measure temperature of foods, a vibrator, a sound giving-off device, and several power sources, which include blue, yellow, and red ones. The implement body has a pervious-to-light portion for light emitted from the light sources to travel through. The vibrator will start vibrating, the sound giving-off device will give off warning sound, and the light sources will emit warning light accordingly if the temperature of the foods is higher than a predetermined value; thus, even if the user is a person with disabilities, he can be aware that the foods are too hot.

### BRIEF DESCRIPTION OF THE DRAWINGS

The present invention will be better understood by referring to the accompanying drawings, wherein:

FIG. 1 is an exploded perspective view of a first preferred embodiment of the present invention,

FIG. 2 is an enlarged perspective view of a warning device of the first preferred embodiment,

FIG. 3 is a perspective view of the first preferred embodiment,

FIG. 4 is a perspective view of a second preferred embodiment,

FIG. 5 is a sectional view of a third preferred embodiment,

FIG. 6 is a sectional view of a fourth preferred embodiment,

FIG. 7 is a perspective view of a fifth preferred embodiment, and

FIG. 8 is a view to illustrating the use of the fifth embodiment.

### DETAILED DESCRIPTION OF THE PREFERRED EMBODIMENTS

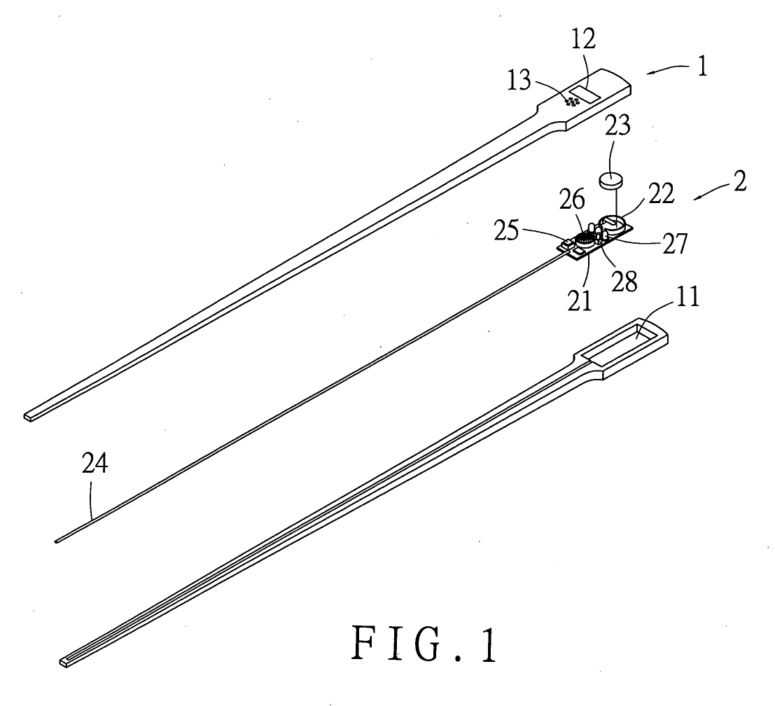

Referring to FIG. 1, a first preferred embodiment of a safe dining implement of the present invention includes a dining implement body 1, and a warning device 2.

The dining implement body 1 can be dishes, knives, thermos bottles, forks, spoons or chopsticks, and it can be made of metallic or nonmetallic materials such as plastics and ceramics. The dining implement body 1 has a holding room 11 to hold the warning device 2. Furthermore, the dining implement body 1 has a pervious-to-light portion 12, and several holes 13, which are on the top or other prominent portions of the dining implement body 1, and next to the holding room 11.

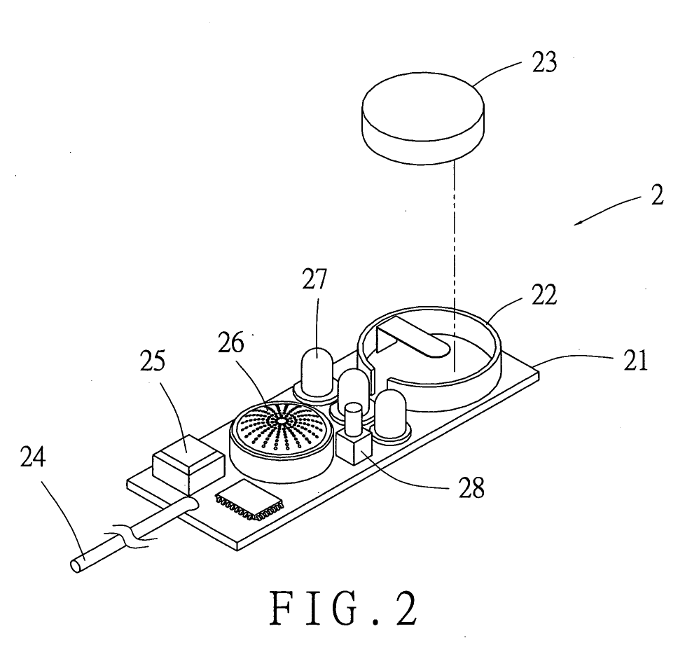

Referring to FIG. 2, the warning device 2 includes a mother board 21, a power source 23, a temperature measuring device 24, a vibrator 25, a sound giving-off device 26, several light sources 27, and a switch 28. The mother board 21 has a holding portion 22. The power source 23 can be a battery set, and it is held in the holding portion 22. The temperature measuring device 24, the vibrator 25, the sound giving-off device 26, and the light sources 27 are connected with the power source 23. The switch 28 is used to control power to the vibrator 25, the sound giving-off device 26, and the light sources 27 so that the vibrator 25, the sound giving-off device 26, and the light sources 27 can be turned on and turn off. The light sources 27 include a light source capable of emitting blue light, one capable of emitting yellow light, and one capable of emitting red light.

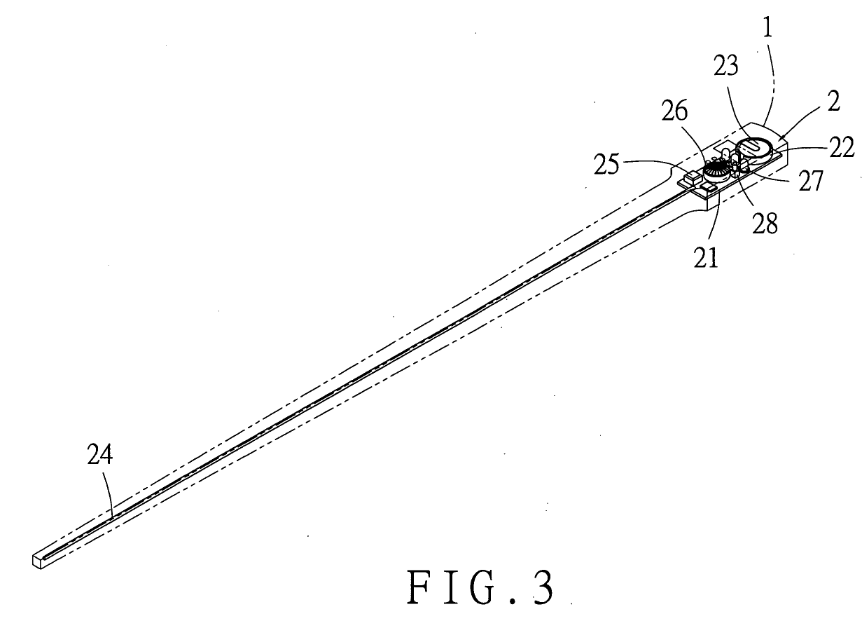

In assembly, referring to FIGS. 1 and 3, the mother board 21 of the warning device 2 is positioned in the holding room 11 of the dining implement body 1, and the light sources 27 are positioned in the holding room 11 so as to face the pervious-to-light portion 12, and the sound giving-off device 26 is positioned in the holding room 11 so as to face the holes 13. And, the temperature measuring device 24 of the warning device 2 is arranged adjacent to a portion of the dining implement body 1 that will contact foods when the dining implement is in use. Therefore, when the dining implement is being used in dining, the temperature measuring device 24 will measure temperature of foods, and the result of the measurement will be sent to the mother board 21 of the warning device 2.

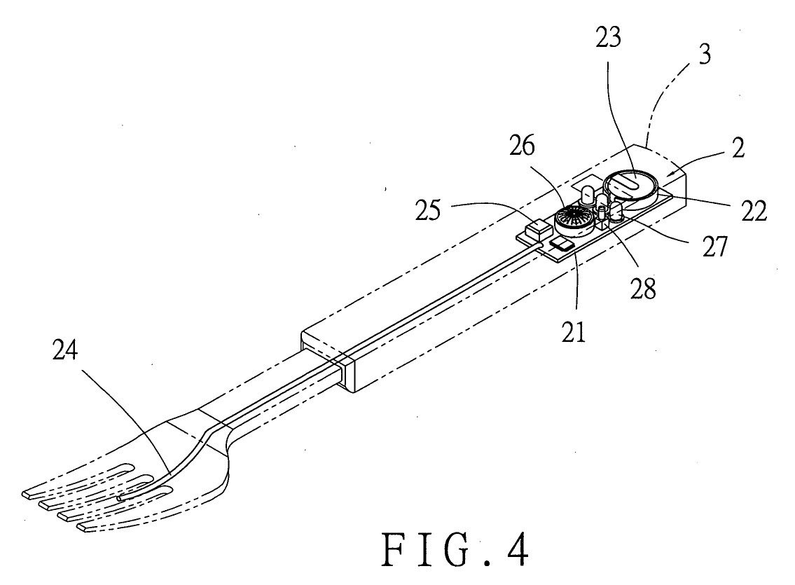

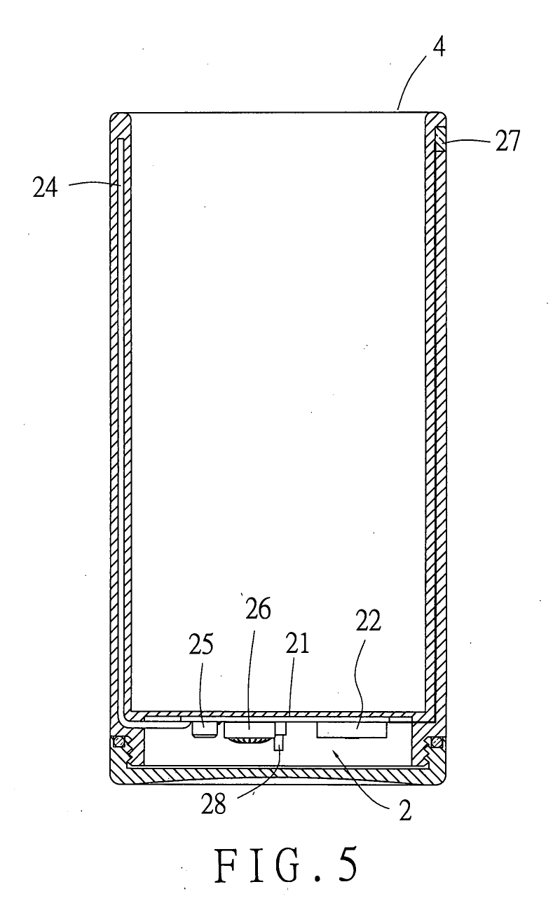

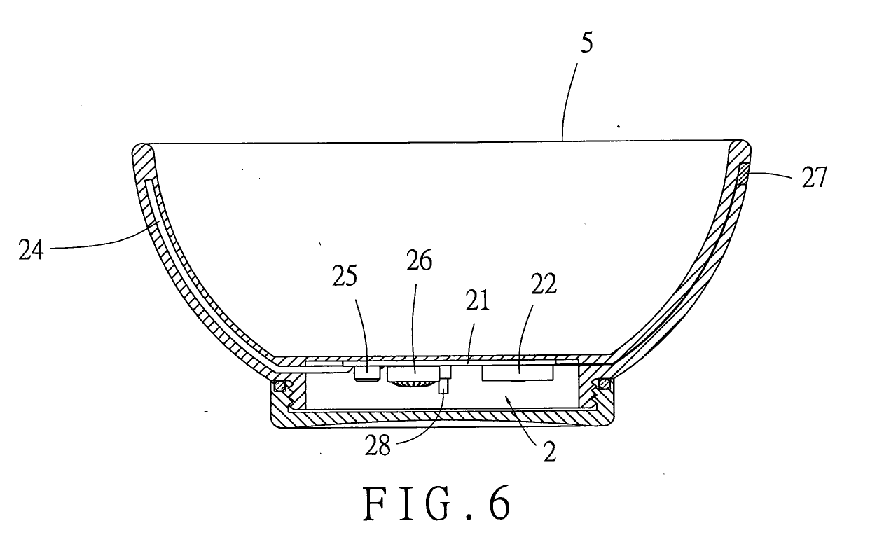

Shown in FIGS. 4, 5, 6, and 7 are second, third, fourth, and fifth preferred embodiments of a safe dining implement of the present invention, which have the same structure as the first preferred embodiment, including a dining implement body 3/4/5/6, and a warning device 2; the dining implement bodies 3, 4, 5, and 6 are a fork, a cup, a bowl, and a spoon respectively. Therefore, the user is allowed to choose from the various safe dining implements according to his/her needs.

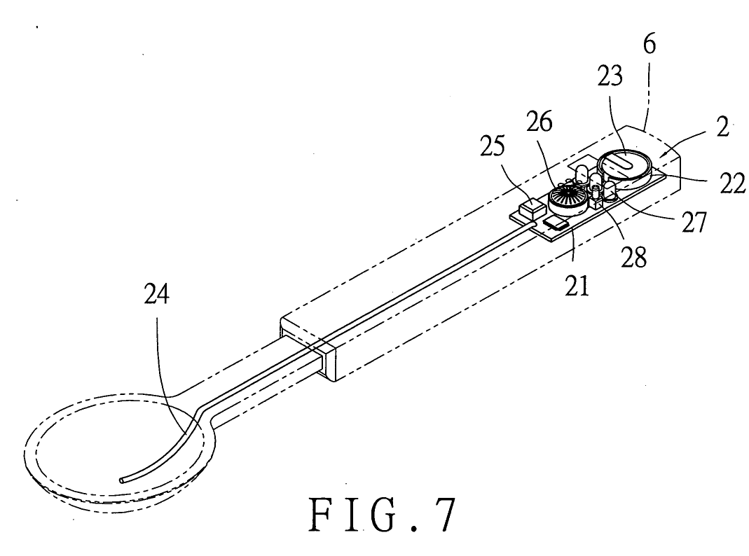

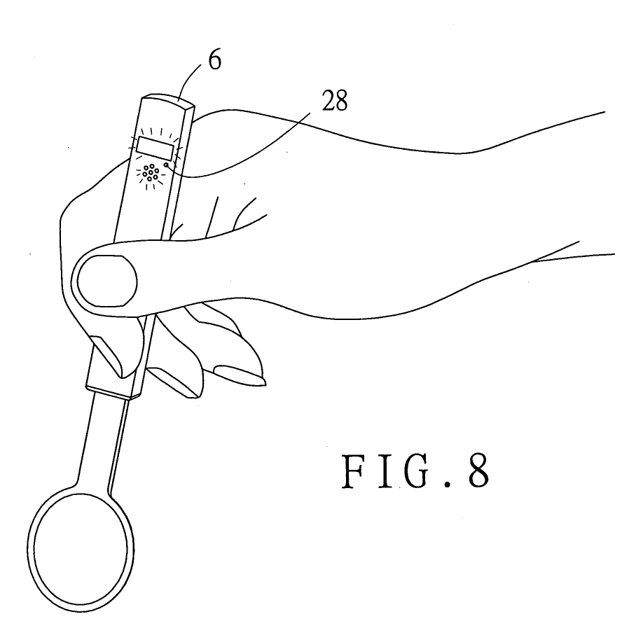

Referring to FIGS. 7 and 8, in use, the temperature measuring device 24 will measure temperature of foods contacting the dining implement, and the result of the measurement will be sent to the mother board 21. If the temperature of the foods is lower than a predetermined low-temperature value, the mother board 21 will make the blue light source 27 to emit blue light to signal to the user; at the same time, the sound giving-off device 26 will give off sound to indicate that the foods are too cool. If the temperature of the foods is within a moderate-temperature range, the mother board 21 will make the yellow light source 27 to emit yellow light to signal to the user; at the same time, the sound giving-off device 26 will give off sound to indicate that the temperature of the foods is moderate. If the temperature of the foods is higher than a predetermined high-temperature value, the mother board 21 will make the red light source 27 to emit red light to signal to the user; at the same time, the sound giving-off device 26 will give off sound to indicate that the foods are too hot, and the vibrator 25 will start vibrating slightly to warn the user/diner. Thus, even if the user is a person with disabilities, he/she can be aware that the foods are too hot, thus preventing himself/herself from getting hurt.

From the above description, it can be seen that the dining implement of the present invention has the following advantages:

1. The dining implement body is equipped with a temperature measuring device. Therefore, a person feeding a little child/elderly person will know whether the temperature of the foods is moderate when the dining implement contacts the foods.

2. The vibrator of the warning device of the dining implement will start vibrating to warn the user if the foods are too hot. Furthermore, the sound giving-off device will give off a particular sound, and the light sources of the warning device emit a certain color light to indicate the current state of the foods, e.g. being too hot, too cool, and at moderate temperature. Consequently, even if the user is a person with visual disabilities, he can be aware of hot temperature of foods without other people's help.

3. The dining implement body is watertight, difficult to dismantle, and resistant to very high and very low temperatures in order to prevent the warning device from getting damaged.

What is claimed is:

1. A safe dining implement structure with temperature measuring and warning function, comprising
a dining implement body; and
a warning device fitted to the dining implement body, the warning device including a power source, a temperature measuring device, a sound producing device, and a light source; the power source, the temperature measuring device, the sound giving-off device, and the light source being connected.

2. The safe dining implement structure with temperature measuring and warning function as claimed in claim 1, wherein the dining implement body is made of metallic materials.

3. The safe dining implement structure with temperature measuring and warning function as claimed in claim 1, wherein the dining implement body is made of plastic materials.

4. The safe dining implement structure with temperature measuring and warning function as claimed in claim 1, wherein the dining implement body is made of ceramic materials.

5. The safe dining implement structure with temperature measuring and warning function as claimed in claim 1, wherein the dining implement body has a holding room, and the warning device is held in the holding room.

6. The safe dining implement structure with temperature measuring and warning function as claimed in claim 1, wherein the warning device includes a mother board, which includes a holding portion, and the power source is held in the holding portion.

7. The safe dining implement structure with temperature measuring and warning function as claimed in claim 1, wherein the warning device is equipped with a switch.

8. The safe dining implement structure with temperature measuring and warning function as claimed in claim 1, wherein the warning device includes a vibrator.

9. The safe dining implement structure with temperature measuring and warning function as claimed in claim 8, wherein the warning device is equipped with a switch.

10. The safe dining implement structure with temperature measuring and warning function as claimed in claim 1, wherein the dining implement body has a pervious-to-light portion.
